(19) United States
(12) Patent Application Publication
(10) Pub. No.: US 2014/0145968 A1
(43) Pub. Date: May 29, 2014

(54) NOTEBOOK WITH REMOTE CONTROL

(71) Applicant: CHENG UEI PRECISION INDUSTRY CO., LTD., New Taipei City (TW)

(72) Inventors: Jung-Kun Hsieh, New Taipei City (TW); Yu-Ping Wang, New Taipei City (TW)

(73) Assignee: CHENG UEI PRECISION INDUSTRY CO., LTD., New Taipei City (TW)

(21) Appl. No.: 13/688,516

(22) Filed: Nov. 29, 2012

(51) Int. Cl. G06F 3/041

(52) U.S. Cl. CPC G06F 3/041
USPC 345/173

(57) ABSTRACT

A notebook with remote control includes a body, a lid hinged to the body with an inner side thereof being equipped with a display screen, a touch screen located at an outer side of the lid for displaying different graphical interfaces in accordance with a display signal and generating a coordinate signal of a close position when a user presses the touch screen on the basis of the graphical interfaces, a processing unit electrically connected with the touch screen for applying the display signal to the touch screen and processing the coordinate signal from the touch screen and generating a control signal corresponding to the coordinate signal, and a wireless transmission module electrically connected with the processing unit for transmitting the control signal to remote control a requested electronic product.

### BACKGROUND OF THE INVENTION

1. Field of the Invention

The present invention relates to a notebook, particularly refers to a notebook with remote control capable of remote controlling different electronic products.

2. The Related Art

The remote controller is widely used on variety of electronic products in these days. Therefore, a person may own several remote controllers that are only different on their external shapes. As a result, it is apt to confuse the user to find out the correct way to use, furthermore, the storage of remote controllers is also quite inconvenient.

In order to solve these disadvantages above, a new type of remote controller so-called universal remote controller is provided. Many sets of control signal for controlling different kinds of electrical products are preloaded in the universal remote controller. Some of the universal remote controllers can even copy the control signal that is emitted by other remote controller or download new control signal data through the internet. Therefore, the user can control a lot of electronic products with only one universal remote controller.

With the reducing of the production cost of the notebook, the penetration rate of the notebook is increasing. Most of notebooks comprise at least one wireless transmission module such as infrared device or radio frequency device. The electronic product capable of being controlled by the radio frequency is also growing. If the wireless transmission module in the notebook can be combined with the remote control, it will provide users a brand-new experience.

### SUMMARY OF THE INVENTION

An objective of this invention is to provide a notebook with remote control. The notebook with remote control includes a body, a lid hinged to the body with an inner side thereof being equipped with a display screen, a touch screen located at an outer side of the lid for displaying different graphical interfaces in accordance with a display signal and generating a coordinate signal of a close position when a user presses the touch screen on the basis of the graphical interfaces, a processing unit electrically connected with the touch screen for applying the display signal to the touch screen and processing the coordinate signal from the touch screen and generating a control signal corresponding to the coordinate signal, and a wireless transmission module electrically connected with the processing unit for transmitting the control signal to remote control a requested electronic product.

As described above, the notebook with remote control in this invention combines the touch screen and the wireless transmission module together in the notebook to remote control the electronic product. Furthermore, the touch screen is located at the outer side of the lid and powered independently, so users can remote control the electronic product more easily and conveniently.

### BRIEF DESCRIPTION OF THE DRAWINGS

The present invention will be apparent to those skilled in the art by reading the following description, with reference to the attached drawings, in which:

FIG. 1 shows a perspective view of a notebook with remote control according to the present invention;

FIG. 2 shows a functional block diagram of the notebook with remote control of FIG. 1;

FIG. 3 shows a circuit diagram of a power supply circuit of the notebook with remote control of FIG. 1;

FIG. 4 shows one graphical interface of the notebook with remote control of FIG. 1 in use; and

FIG. 5 shows another graphical interface of the notebook with remote control of FIG. 1 in use.

### DETAILED DESCRIPTION OF THE PREFERRED EMBODIMENT

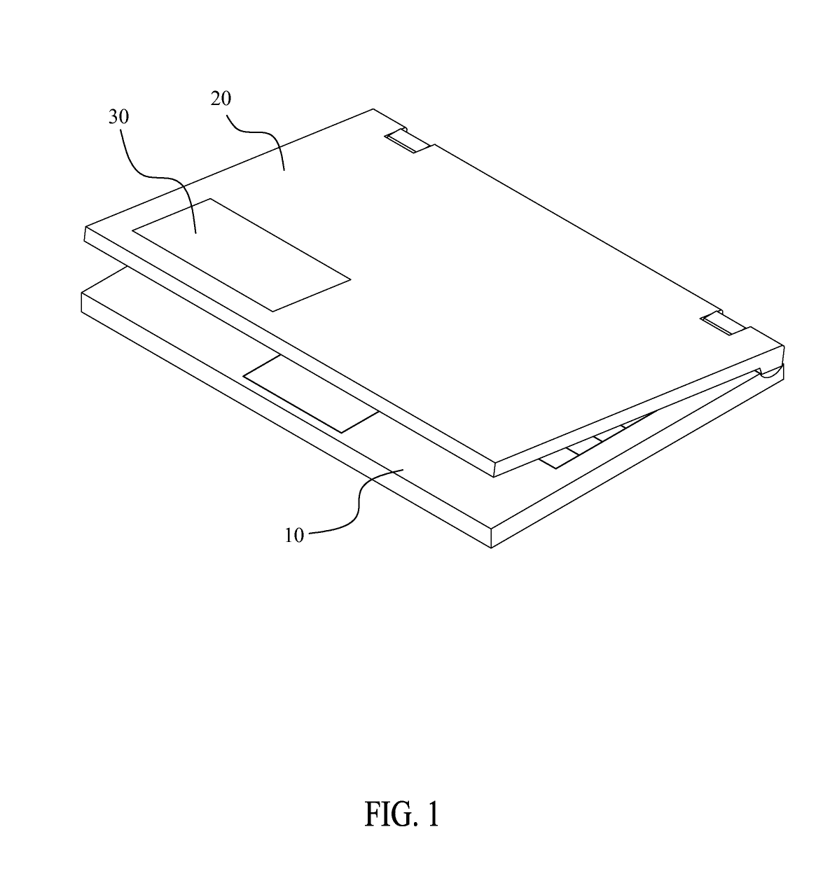

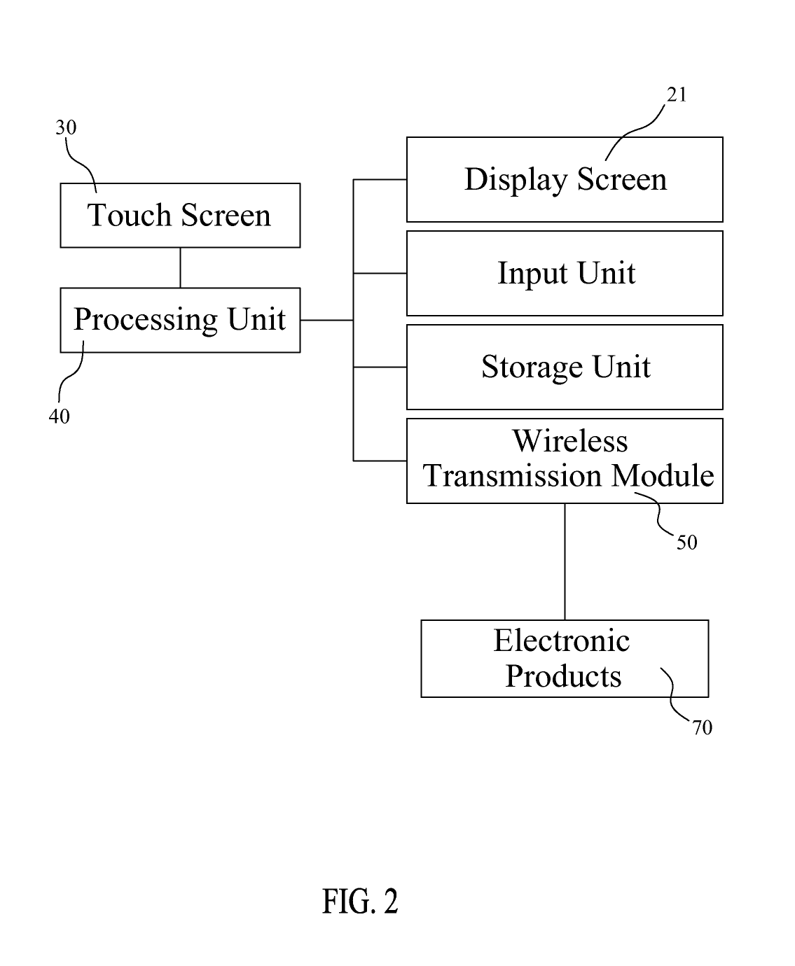

Referring to FIG. 1 and FIG. 2, a notebook with remote control according to the present invention includes a body 10, a lid 20 hinged to the body 10 and equipped with a display screen 21 in an inner side thereof, a touch screen 30 located at an outer side of the lid 20, a processing unit 40 electronically connected with the display screen 21 and the touch screen 30, and a wireless transmission module 50 electronically connected with the processing unit 40.

The display screen 21 is used for displaying information when a user operates the notebook for general use. The touch screen 30 can show different graphical interfaces in accordance with a display signal and generate a coordinate signal of a close position when the user presses the touch screen 30 on the basis of the graphical interfaces. The processing unit 40 is used for applying the display signals to the touch screen 30, receiving the coordinate signals from the touch screen 30 and generating a control signal corresponding to the coordinate signal. The wireless transmission module 50 receives the control signal and then utilizes the control signal to remote control a requested electronic product 70.

The wireless transmission module 50 can be one of the following built-in or external device: an infrared transmission device, a Bluetooth device, a ZigBee device or a Wi-Fi device. Because the wireless transmission module 50 used for remote control is shared with the notebook, the overall structure of the notebook with remote control can be simplified.

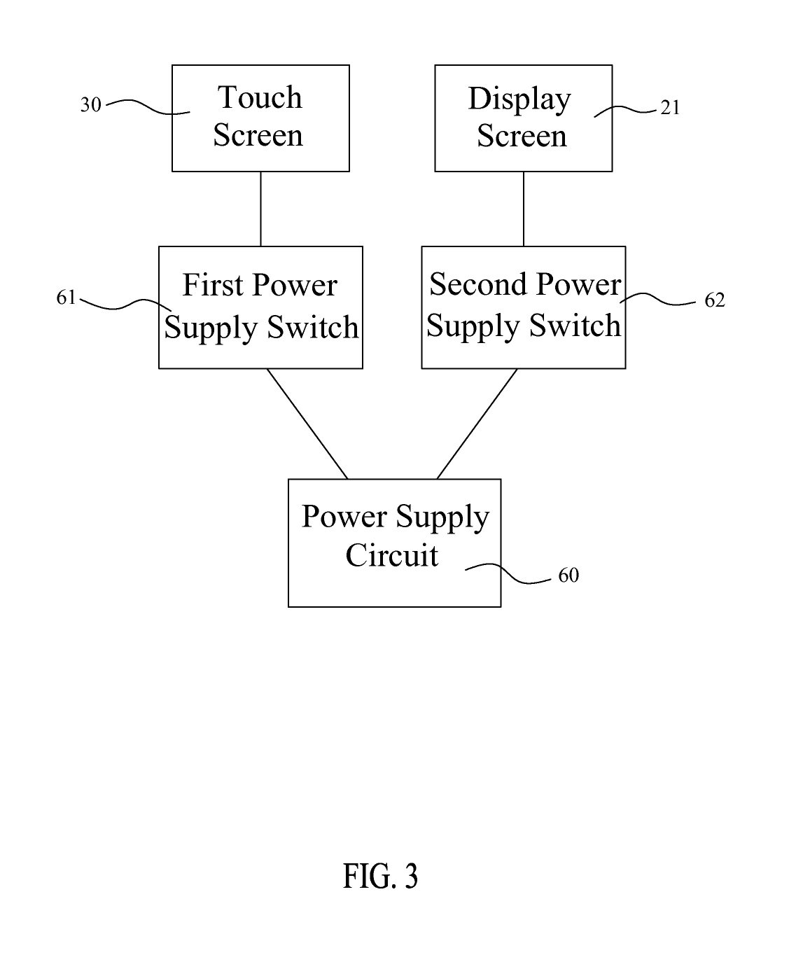

Referring to FIG. 3, in order to reduce the number of components and the size of the notebook, a power supply circuit 60 is used to supply power to the display screen 21 and the touch screen 30. In detail, the power supply circuit 60 connects the touch screen 30 by means of a first power supply switch 61 to independently control power supply states of the touch screen 30. The power supply circuit 60 connects the display screen 21 by means of a second power supply switch 62 to independently control power supply states of the display screen 21. So the touch screen 30 can be use independently even when the display screen 21 is turned off.

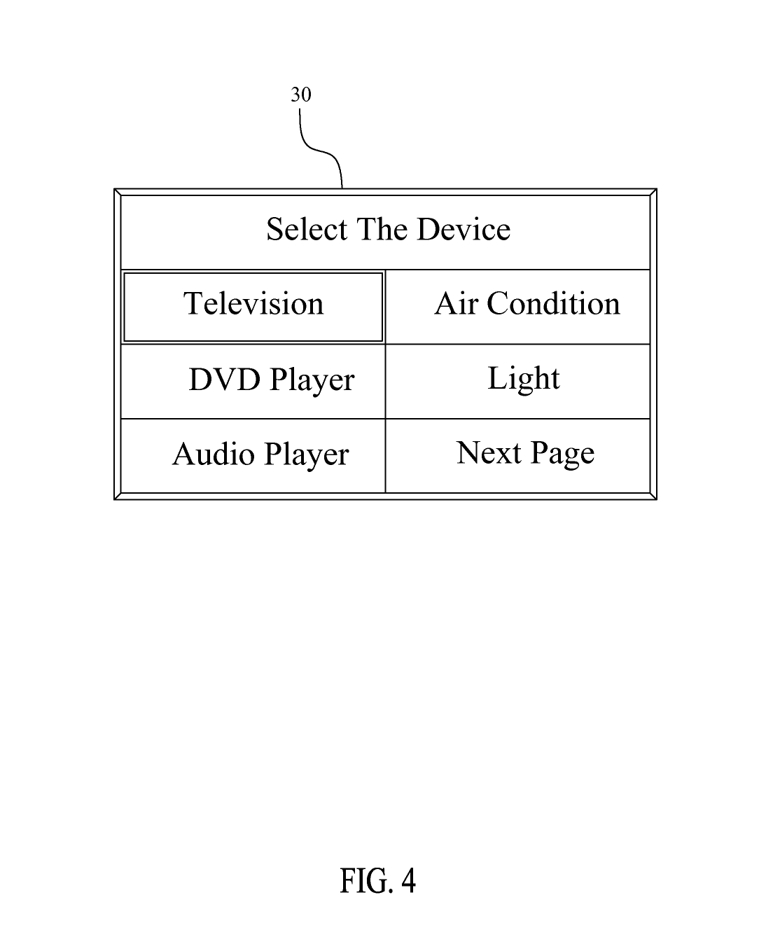

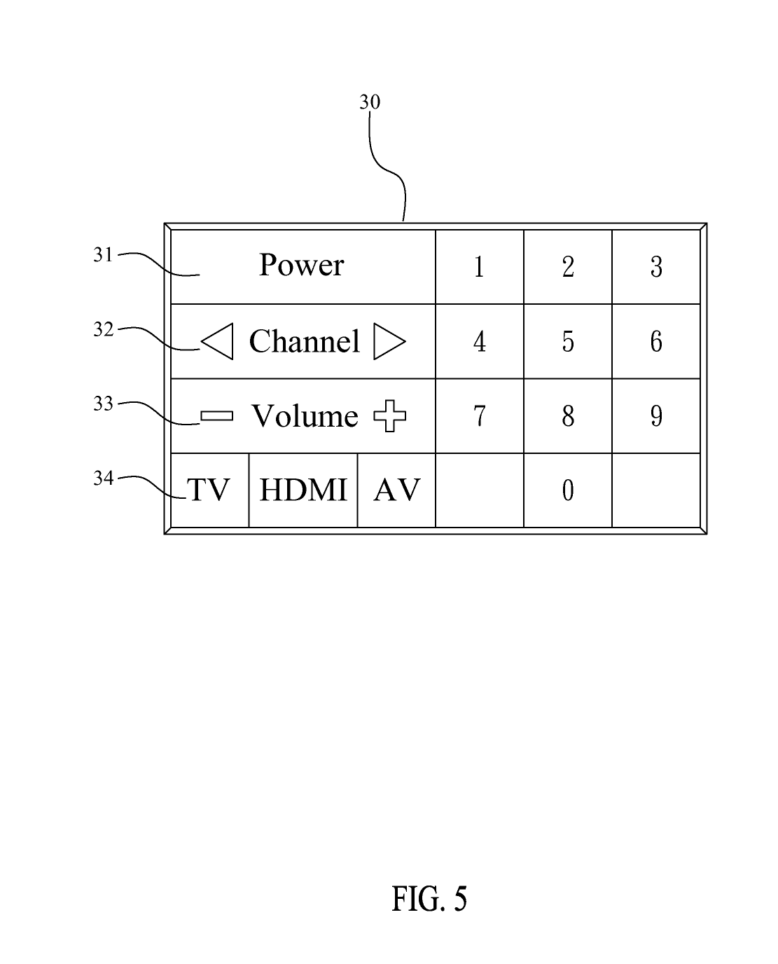

Referring to FIG. 2, FIG. 4 and FIG. 5, take the controlling of TV for example to describe the working principle of the notebook. First, turn on the first power supply switch 61 to make the power supply circuit 60 supply power for the touch screen 30, meanwhile, the processing unit 40 sends a display signal to display a graphical interface on the touch screen 30 that shows a list of the electronic products 70 available now on the touch screen 30.

Then the user chooses the electronic product 70 requested to control by touching a corresponding position of the graphical interface shown on the touch screen 30. The touch screen 30 will generate a coordinate signal according to the position touched by the user and send the coordinate signal to the processing unit 40. The processing unit 40 processes the coordinate signal and generates a corresponding control signal based on the coordinate signal. In this embodiment, the user presses a block that is signed with Television, after the processing unit 40 identifies the coordinate signal it will generate a control signal for displaying a TV control menu. According to the response to the control signal, the processing unit 40 will provide another display signal to display another graphical interface on the touch screen 30 that shows control options, including the functions such as the power 31, Channel selection 32, volume adjustment 33, and signal input source switching 34 on the touch screen 30 (as shown in FIG. 5).

After the user operates a desired action on the touch screen 30, the touch screen 30 generates a second coordinate signal of the close position, and sends the second coordinate signal to the processing unit 40. The processing unit 40 processes the second coordinate signal to generate a corresponding control signal based on the processed result. Then the wireless transmission module 50 utilizes the control signal to remote control the television.

As described above, the notebook with remote control in this invention combines the touch screen 30 and the wireless transmission module 50 together in the notebook to remote control the electronic products 70. Furthermore, the touch screen 30 is located at the outer side of the lid 20 and powered independently, so users can remote control the electronic product 70 more easily and conveniently.

What is claimed is:

1. A notebook with remote control, comprising:
a body;
a lid hinged to the body, an inner side of the lid being equipped with a display screen;
a touch screen located at an outer side of the lid for displaying different graphical interfaces in accordance with a display signal, and generating a coordinate signal of a close position when a user presses the touch screen on the basis of the graphical interfaces;
a processing unit electrically connected with the touch screen for applying the display signal to the touch screen, processing the coordinate signal from the touch screen and generating a control signal corresponding to the coordinate signal; and
a wireless transmission module electrically connected with the processing unit for transmitting the control signal to remote control a requested electronic product.

2. The notebook as claimed in claim 1, wherein the wireless transmission module is an infrared device.

3. The notebook as claimed in claim 1, wherein the wireless transmission module is a Bluetooth device.

4. The notebook as claimed in claim 1, wherein the wireless transmission module is a ZigBee device.

5. The notebook as claimed in claim 1, wherein the wireless transmission module is a Wi-Fi device.

6. The notebook as claimed in claim 1, further comprising a power supply circuit for supplying power to the display screen and the touch screen, the power supply circuit connects the touch screen by means of a first power supply switch to independently control the power supply states of the touch screen, the power supply circuit connects the display screen by means of a second power supply switch to independently control the power supply states of the display screen.
